(19) United States
(12) Patent Application Publication
(10) Pub. No.: US 2020/0086838 A1
(43) Pub. Date: Mar. 19, 2020

(54) CONTROL SYSTEM AND METHOD FOR PREVENTING SUDDEN ACCELERATION OF VEHICLE

(71) Applicants: Hyundai Motor Company, Seoul (KR); Kia Motors Corporation, Seoul (KR)

(72) Inventor: Chul Yun, Hwaseong (KR)

(21) Appl. No.: 16/183,096

(22) Filed: Nov. 7, 2018

(30) Foreign Application Priority Data
Sep. 17, 2018 (KR) 10-2018-0110706

(51) Int. Cl. B60T 8/32; G07C 5/02; B60T 8/44

(52) U.S. Cl. CPC B60T 8/3205; B60T 2220/04; B60T 8/444; G07C 5/02

(57) ABSTRACT

A control system for preventing sudden acceleration of a vehicle is provided. The system includes a sensor unit that detects engine RPM of a vehicle, a speed, a depressed state of an accelerator pedal, a depressed state of a brake pedal, and vacuum pressure of a brake booster. A hydraulic pressure compensation unit compensates hydraulic pressure of a brake and a controller determines whether the vehicle is suddenly accelerated based on at least one or more items of information of the engine RPM of the vehicle, the speed, the depressed state of the accelerator pedal, and the depressed state of the brake pedal detected by the sensor unit. The controller then compensates braking force of the brake by generating hydraulic pressure through the hydraulic pressure compensation unit when the vehicle is suddenly accelerated.

### CROSS REFERENCE TO RELATED APPLICATION

The present application claims priority to Korean Patent Application No. 10-2018-0110706, filed on Sep. 17, 2018 the entire contents of which is incorporated herein for all purposes by this reference.

### BACKGROUND

### 1. Field of the Disclosure

The present disclosure relates to a control system and method for preventing sudden acceleration of a vehicle and, more particularly, to a control system and method for preventing an accident due to sudden acceleration by compensating for the braking force of a brake system by generating hydraulic pressure.

### 2. Description of the Prior Art

Recently, accidents due to sudden acceleration of vehicles frequently occur. The sudden acceleration of a vehicle may occur for various reasons but typically refers to a vehicle unexpectedly driven forward or backward even without a driver intentionally engaging the accelerator pedal or shifting since a throttle valve opens, the revolutions per minute (RPM) of an engine increases, and a driving shaft is intentionally rotated even though the driver does not engage the accelerator pedal with the engine in operation. When a vehicle is unintentionally driven forward or backward, the vehicle may be damaged and the driver of the vehicle and pedestrians walking near the vehicle may be faced with a dangerous situation.

Meanwhile, engine control including engine torque control/driving shaft control has been used to prevent the sudden acceleration of vehicles in the related art, but according to the actual examples of accidents, engines were not accurately controlled when sudden acceleration occurred, which has resulted in an increased number of accidents. Further, when sudden acceleration occurs, an engine throttle valve excessively opens and boosting pressure is not generated in a brake booster, and thus the booster is unable to normally boost braking force even though a brake pedal is depressed. Accordingly, even though a driver engages a brake pedal, a vehicle is not normally stopped in many cases.

The description provided above as a related art of the present disclosure is merely for helping understanding the background of the present disclosure and should not be construed as being included in the related art known by those skilled in the art.

### SUMMARY

The present disclosure provides a control system and method for preventing sudden acceleration of a vehicle. The system and method are able to further improve the stability of a vehicle when the vehicle is suddenly accelerated, by determining whether the vehicle is suddenly accelerated, based on at least one or more items of information of engine RPM of the vehicle, a speed, a depressed state of an accelerator pedal, and a depressed state of a brake pedal detected by a sensor unit, and by compensating braking force of the brake by generating hydraulic pressure through a hydraulic pressure compensation unit when the vehicle is suddenly accelerated.

In order to achieve the aspects, a control system for preventing sudden acceleration of a vehicle according to the present disclosure may include: a sensor unit configured to detect engine RPM of a vehicle, a speed, a depressed state of an accelerator pedal, a depressed state of a brake pedal, and vacuum pressure of a brake booster; a hydraulic pressure compensation unit configured to compensate hydraulic pressure of a brake; and a controller configured to determine whether the vehicle is suddenly accelerated based on at least one or more items of information of the engine RPM of the vehicle, the speed, the depressed state of the accelerator pedal, and the depressed state of the brake pedal detected by the sensor unit, and configured to compensate braking force of the brake by generating hydraulic pressure through the hydraulic pressure compensation unit when the vehicle is suddenly accelerated.

The sensor unit may include at least one or more of: an engine RPM detector configured to detect the engine RPM; a speed detector which may be a wheel speed sensor mounted on wheels of the vehicle and configured to detect the speed of the wheels; an accelerator pedal-depressed state detector configured to detect the depressed state of the accelerator pedal; a brake pedal-depressed state detector configured to detect the depressed state of the brake pedal; and a vacuum pressure detector configured to detect vacuum pressure of the booster.

The controller may include: a sudden acceleration state determiner configured to determine whether the vehicle is suddenly accelerated based on at least one or more items of information of the engine RPM of the vehicle, the speed, the depressed state of the accelerator pedal, and the depressed state of the brake pedal detected by the sensor unit; and a hydraulic pressure compensation signal generator configured to generate a hydraulic pressure compensation signal so that the hydraulic pressure compensation unit compensates hydraulic pressure based on at least one or more items of information of the vacuum pressure of the booster, the depressed state of the brake pedal, and a deceleration state of the vehicle when the vehicle is suddenly accelerated.

The sudden acceleration state determiner may be configured to start to determine whether the vehicle is suddenly accelerated when the current detected engine RPM of the vehicle is greater than predetermined engine RPM without the accelerator pedal engagement. Additionally, the sudden acceleration state determiner may be configured to determine that the vehicle is suddenly accelerated, when the accelerator pedal is depressed, the current detected engine RPM of the vehicle is greater than predetermined engine RPM, the speed of the vehicle is a predetermined speed or greater, and the vehicle is not decelerated with the brake pedal engaged.

When the detected vacuum pressure of the booster is less than predetermined vacuum pressure, the hydraulic pressure compensation signal generator may be configured to determine a hydraulic pressure compensation amount based on the detected vacuum pressure of the booster and generate a hydraulic pressure compensation signal so that the hydraulic pressure compensation unit compensates hydraulic pressure. When the vehicle is not decelerated with the brake pedal engaged, the hydraulic pressure compensation signal generator may be configured to generate a hydraulic pressure compensation signal so that the hydraulic pressure compensation unit compensates hydraulic pressure.

The hydraulic pressure compensation unit may be configured to compensate hydraulic pressure of the brake by generating hydraulic pressure by operating a motor and a valve of an Electric Stability Control (ESC) in response to a hydraulic compensation signal generated by the hydraulic pressure compensation signal generator. The control system may further include a parking brake operation unit configured to that automatically operate a parking brake of the vehicle. The controller may be configured to operate the parking brake operation unit to stop a vehicle, when the speed of the vehicle becomes a predetermined speed or less by compensating the braking force of the brake by generating hydraulic pressure through the hydraulic pressure compensation unit in response to determining that the vehicle is suddenly accelerated.

In order to achieve the aspects, a control method for preventing sudden acceleration of a vehicle according to the present disclosure may include: determining whether a vehicle is suddenly accelerated based on at least one or more items of information of engine RPM of a vehicle, speed, a depressed state of an accelerator pedal, and a depressed state of a brake pedal detected by a sensor unit; and compensating braking force of a brake by generating hydraulic pressure through a hydraulic pressure compensation unit in response to determining that the vehicle is suddenly accelerated.

The determining of whether the vehicle is suddenly accelerated may include: determining whether the current engine RPM of the vehicle is greater than predetermined reference engine RPM, and a depressed state of the accelerator pedal; comparing the current speed of the vehicle with a predetermined reference speed when determining that the current engine RPM of the vehicle is greater than the predetermined reference engine RPM without the accelerator pedal engaged; and determining whether the vehicle is decelerated, and the depressed state of the brake pedal in response to determining that the current speed of the vehicle is greater than the predetermined reference speed, and determining that the vehicle is suddenly accelerated in response to determining that the vehicle is not decelerated with the brake pedal engaged.

The compensating of braking force of a brake may include: generating a hydraulic pressure compensation signal so that the hydraulic pressure compensation unit compensates hydraulic pressure by determining a hydraulic pressure compensation amount based on the detected vacuum pressure of a booster when the detected vacuum pressure of the booster is less than predetermined vacuum pressure; and primarily compensating hydraulic pressure of a brake by generating hydraulic pressure by operating a motor and a valve of an ESC in response to the hydraulic pressure compensation signal through a hydraulic pressure compensation unit.

The control method may further include: after the primarily compensating of hydraulic pressure of a brake, determining a depressed state of the brake pedal; determining whether the vehicle is decelerated when the brake pedal is engaged; and secondarily compensating the hydraulic pressure of the brake by generating hydraulic pressure by operating a motor and a valve of an ESC through the hydraulic pressure compensation unit when the vehicle is not decelerated. The method may further include, after the secondarily compensating of hydraulic pressure, stopping the vehicle by operating a parking brake operation unit when the speed of the vehicle becomes a predetermined speed or less.

According to the present disclosure, it may be possible to further improve stability of a vehicle when the vehicle is suddenly accelerated, by determining whether the vehicle is suddenly accelerated, based on at least one or more items of information of the engine RPM of the vehicle, the speed, the depressed state of an accelerator pedal, and the depressed state of a brake pedal detected by the sensor unit, and by compensating braking force of the brake by generating hydraulic pressure through the hydraulic pressure compensation unit when the vehicle is suddenly accelerated.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a block diagram showing the entire configuration of a control system for preventing sudden acceleration of a vehicle according to an exemplary embodiment of the present disclosure;

FIG. 2 is a flowchart showing a control method for preventing sudden acceleration of a vehicle according to an exemplary embodiment of the present disclosure;

FIG. 3 is a flowchart showing a process of determining whether a vehicle is suddenly accelerated in the control method for preventing sudden acceleration of a vehicle according to an exemplary embodiment of the present disclosure; and

FIG. 4 is a flowchart showing a process of compensating hydraulic pressure to a brake when sudden acceleration occurs in the control method for preventing sudden acceleration of a vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

A control system and method for preventing sudden acceleration of a vehicle according to an exemplary embodiment of the present disclosure will be described herein with reference to the accompanying drawings.

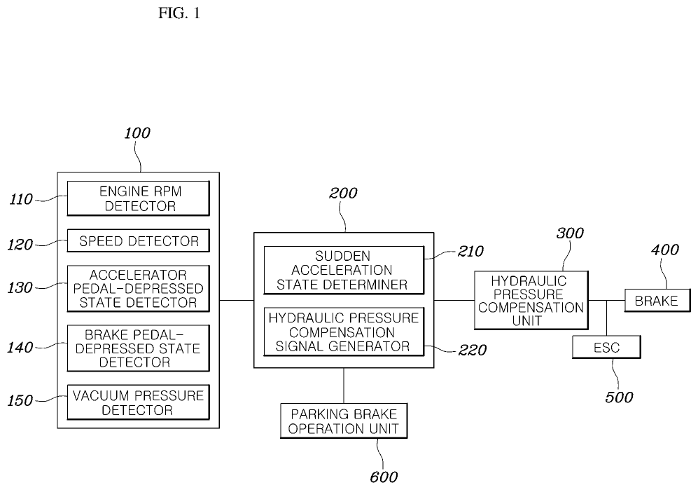

FIG. 1 is a block diagram showing the entire configuration of a control system for preventing sudden acceleration of a vehicle according to an exemplary embodiment of the present disclosure. As shown in FIG. 1, a control system for preventing sudden acceleration of a vehicle according to an exemplary embodiment of the present disclosure may include: a sensor unit 100 configured to detect engine RPM of a vehicle, a speed, a depressed state of an accelerator pedal, a depressed state of a brake pedal, and vacuum pressure of a brake booster; a hydraulic pressure compensation unit 300 configured to compensate hydraulic pressure of a brake 400; and a controller 200 configured to determine whether the vehicle is suddenly accelerated based on at least one or more items of information of the engine RPM of a vehicle, the speed, the depressed state of the accelerator pedal, and the depressed state of the brake pedal detected by the sensor unit 100, and configured to compensate braking force of the brake 400 by generating hydraulic pressure using the hydraulic pressure compensation unit 300 when the vehicle is suddenly accelerated. The detailed configuration of the control system for preventing sudden acceleration of a vehicle is described in detail hereafter.

The sensor unit 100, as shown in FIG. 1, may include at least one or more of an engine RPM detector 110, a speed detector 120, an accelerator pedal-depressed state detector 130, a brake pedal-depressed state detector 140, and a vacuum pressure detector 150. In particular, the engine RPM detector 110 may be configured detect the RPM of an engine. Depending on exemplary embodiments, the engine RPM detector 110 may be a crankshaft position sensor (CKPS) and engine RPM may be detected by the sensor. However, the crankshaft position sensor is merely an exemplary embodiment, the engine RPM detector is not limited thereto, and various sensors may be used as the engine RPM detector of the present disclosure capable of detecting engine RPM. Engine RPM information detected by the engine RPM detector 110 may be provided as an electrical signal to the controller 200. In other words, the sensing result may be transmitted to the controller 200.

Additionally, the speed detector 120 may be wheel speed sensor mounted on the wheels of a vehicle and may be configured to detect the speed of the wheels and the detected speed information of the wheels may be provided as an electrical signal to the controller 200. The accelerator pedal-depressed state detector 130 may be configured to detect the depressed state of an accelerator pedal. The depressed state of an accelerator pedal may be state information regarding whether an accelerator pedal is engaged or an engagement amount (e.g., amount of force exerted onto the accelerator pedal by the driver). Depending on exemplary embodiments, the accelerator pedal-depressed state detector 130 may be an accelerator position sensor (APS) or a throttle position sensor (TPS) and the depressed state of an accelerator pedal may be detected by the sensor. The detected accelerator pedal-depressed state information may be provided as an electrical signal to the controller 200.

The brake pedal-depressed state detector 140 may be configured to detect the depressed state of a brake pedal. The depressed state of a brake pedal may be state information regarding whether a brake pedal is engaged by a driver. Depending on exemplary embodiments, the brake pedal-depressed state detector 140 may be a brake pedal switch and the depressed state of a brake pedal may be detected by the switch. For example, the brake pedal-depressed state detector may be configured to determine that the brake pedal has been depressed or engaged when the brake pedal switch is turned on, and determine that the brake pedal is disengaged when the brake pedal switch is not turned on (e.g., remains switched off). The brake pedal-depressed state information detected by the brake pedal-depressed state detector 140 may be provided as an electrical signal to the controller 200.

The vacuum pressure detector 150 may be configured detect vacuum pressure of a brake booster. Depending on exemplary embodiments, the vacuum pressure detector 150 may be a vacuum sensor and vacuum pressure of the booster may be detected by the sensor. The vacuum pressure information detected by the vacuum pressure detector 150 may be provided as an electrical signal to the controller 200. The controller 200, as shown in FIG. 1, may include a sudden acceleration state determiner 210 and a hydraulic pressure compensation signal generator 220.

In particular, the sudden acceleration state determiner 210 may be configured to determine whether a vehicle is suddenly accelerated based on at least one or more items of information of the engine RPM of the vehicle, the speed, the depressed state of the accelerator pedal, and the depressed state of the brake pedal detected by the sensor unit 100. In particular, the sudden acceleration state determiner 210 may be configured to start to determine whether a vehicle is suddenly accelerated when the current detected engine RPM of the vehicle is greater than predetermined engine RPM without the accelerator pedal engaged (e.g., the accelerator pedal is disengaged). In other words, the sudden acceleration state determiner 210 may be configured to start to determine whether the vehicle is suddenly accelerated when the engine RPM of the vehicle increases over specific engine RPM even without the accelerator pedal depressed by a driver.

Further, the sudden acceleration state determiner 210 may be configured to determine that a vehicle is suddenly accelerated, when the accelerator pedal is disengaged, the current detected engine RPM of the vehicle is greater than predetermined engine RPM, the speed of the vehicle is a predetermined speed or greater, and the vehicle is not decelerated with the brake pedal engaged. In other words, the sudden acceleration state determiner 210 may be configured to determine that a vehicle is suddenly accelerated when the engine RPM of the vehicle increases over predetermined engine RPM without the accelerator pedal depressed a driver and the vehicle is accelerated over a predetermined speed without decelerating even though the driver has engaged the brake pedal.

The hydraulic pressure compensation signal generator 220 may be configured to generate a hydraulic pressure compensation signal to cause the hydraulic pressure compensation unit 300 to compensate hydraulic pressure based on at least one or more items of information of the vacuum pressure of the booster, the depressed state of the brake pedal, and a deceleration state of a vehicle detected by the sensor unit 100, in response to determining that the vehicle is suddenly accelerated by the sudden acceleration state determiner 210.

In particular, when the detected vacuum pressure of the booster is less than predetermined vacuum pressure, the hydraulic pressure compensation signal generator 220 may be configured to determine a hydraulic pressure compensation amount based on the detected vacuum pressure of the booster and may be configured to generate a hydraulic pressure compensation signal to cause the hydraulic pressure compensation unit 300 to compensate hydraulic pressure.

In general, an engine throttle valve may open when sudden acceleration occurs, and in this case, the boosting pressure of a booster of a brake connected to an engine surge tank through a vacuum line decreases and changes into a static pressure state. In other words, the vacuum line may be filled with the atmospheric air and the pressure in the booster may become a static pressure state. Particularly, the booster may be unable to apply boosting action by a pressure difference even when a driver engages the brake pedal. In other words, the lower the vacuum pressure of the booster, the more braking force the booster may apply through boosting due to a pressure difference.

In the present disclosure, when vacuum pressure of a booster is detected and the detected vacuum pressure of the booster is less than predetermined vacuum pressure, that is, when greater braking force may be unable to be applied by boosting of the booster, a hydraulic pressure compensation amount may be determined based on the detected vacuum pressure and hydraulic pressure may be compensated by the hydraulic pressure compensation unit 300, whereby braking force may be compensated.

Further, when a vehicle is not decelerated with a brake pedal engaged, the hydraulic pressure compensation signal generator 220 may be configured generate a hydraulic pressure compensation signal to cause the hydraulic pressure compensation unit 300 to compensate hydraulic pressure. In other words, when a vehicle is not decelerated even though a driver engages a brake pedal with a vehicle suddenly accelerated, the hydraulic pressure compensation signal generator 220 may be configured to generate a hydraulic pressure compensation signal to cause the hydraulic pressure compensation unit 300 to compensate hydraulic pressure.

The hydraulic pressure compensation unit 300 may be configured to compensate hydraulic pressure of the brake 400. In particular, the hydraulic pressure compensation unit 300 may be configured to compensate braking force of the brake 400 by generating hydraulic pressure in response to a signal generated by the hydraulic pressure compensation signal generator 220. The hydraulic pressure compensation unit 300 may be configured to generate hydraulic pressure by operating a motor and a valve of an electric stability control (ESC) 500 in response to a hydraulic compensation signal generated by the hydraulic pressure compensation signal generator 220 to provide stable braking force by compensating hydraulic pressure of the brake 400.

A parking brake operation unit 600 may be configured to automatically operate a parking brake of a vehicle. Depending on exemplary embodiments, the parking brake operation unit 600 may be an electric parking brake (EPB) system and may secure stability in braking of a vehicle in an emergency by automatically operating or stopping a parking brake. The controller 200 may be configured to operate the parking brake operation unit 600 to stop a vehicle when the speed of the vehicle becomes a predetermined speed or less by compensating the braking force of the brake 400 by generating hydraulic pressure through the hydraulic pressure compensation unit 300 in response to determining that the vehicle is suddenly accelerated.

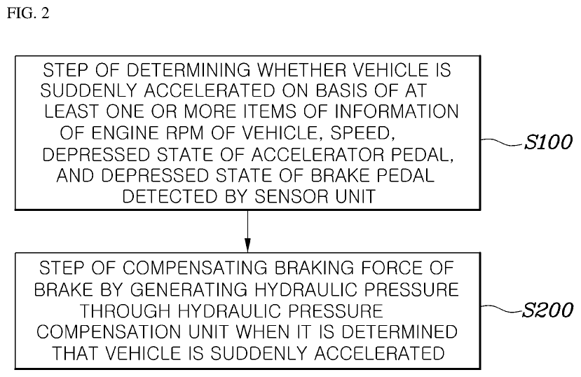

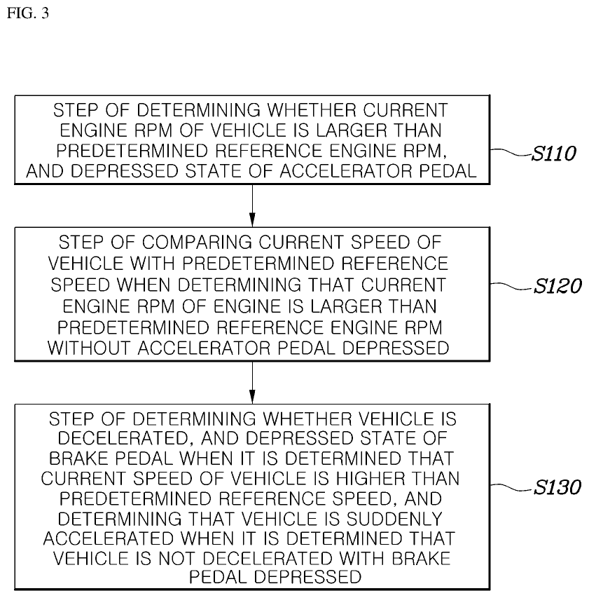

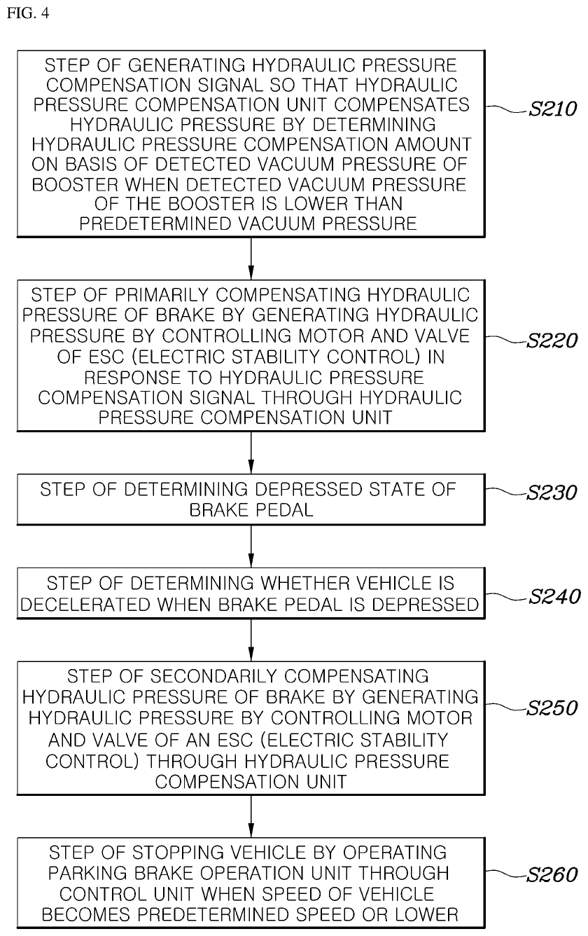

FIG. 2 is a flowchart showing a control method for preventing sudden acceleration of a vehicle according to an exemplary embodiment of the present disclosure. FIG. 3 is a flowchart showing a process of determining whether a vehicle is suddenly accelerated in the control method for preventing sudden acceleration of a vehicle according to an exemplary embodiment of the present disclosure, and FIG. 4 is a flowchart showing a process of compensating hydraulic pressure to a brake when sudden acceleration occurs in the control method for preventing sudden acceleration of a vehicle according to an exemplary embodiment of the present disclosure. The method described herein below may be executed by a controller having a processor and a memory.

The control method for preventing sudden acceleration of a vehicle according to an exemplary embodiment of the present disclosure may include: determining whether a vehicle is suddenly accelerated based on at least one or more items of information of engine RPM of a vehicle, a speed, a depressed state of an accelerator pedal, and a depressed state of a brake pedal detected by a sensor unit; and compensating braking force of a brake by generating hydraulic pressure through a hydraulic pressure compensation unit in response to determining that the vehicle is suddenly accelerated.

Particularly, the determining of whether the vehicle is suddenly accelerated may include: determining whether the current engine RPM of the vehicle is greater than predetermined reference engine RPM, and a depressed state of an accelerator pedal; comparing the current speed of the vehicle with a predetermined reference speed when determining that the current engine RPM of the engine is greater than the predetermined reference engine RPM without the accelerator pedal engaged; and determining whether the vehicle is decelerated, and the depressed state of the brake pedal in response to determining that the current speed of the vehicle is greater than the predetermined reference speed, and determining that the vehicle is suddenly accelerated in response to determining that the vehicle is not decelerated with the brake pedal engaged.

The compensating of braking force of a brake may include: receiving a hydraulic pressure compensation signal from a hydraulic pressure compensation unit to compensate hydraulic pressure by determining a hydraulic pressure compensation amount based on the detected vacuum pressure of a booster when the detected vacuum pressure of the booster is less than predetermined vacuum pressure; and primarily compensating hydraulic pressure of a brake by generating hydraulic pressure by operating a motor and a valve of an ESC in response to the hydraulic pressure compensation signal.

Further, after the primarily compensating of hydraulic pressure of a brake, the method may further include: determining a depressed state of the brake pedal; determining whether the vehicle is decelerated when the brake pedal is depressed; and secondarily compensating the hydraulic pressure of the brake by generating hydraulic pressure by operating the motor and the valve of the ESC when the vehicle is not decelerated. The magnitude of the hydraulic pressure that is primarily compensated and the magnitude of the hydraulic pressure that is secondarily compensated may be the same or different, depending on exemplary embodiments. After the secondarily compensating of hydraulic pressure, the method may further include stopping the vehicle by operating a parking brake operation unit when the speed of the vehicle becomes a predetermined speed or less.

As described above, according to the present disclosure, it may be possible to further improve stability of a vehicle when the vehicle is suddenly accelerated, by determining whether the vehicle is suddenly accelerated, based on at least one or more items of information of the engine RPM of the vehicle, the speed, the depressed state of the accelerator pedal, and the depressed state of the brake pedal detected by the sensor unit, and by compensating braking force of the brake by generating hydraulic pressure through the hydraulic pressure compensation unit when the vehicle is suddenly accelerated.

What is claimed is:

1. A control system for preventing sudden acceleration of a vehicle, comprising:
a sensor unit configured to detect engine revolutions per minute (RPM) of a vehicle, a speed, a depressed state of an accelerator pedal, a depressed state of a brake pedal, and vacuum pressure of a brake booster;
a hydraulic pressure compensation unit configured to compensate hydraulic pressure of a brake; and
a controller configured to determine whether the vehicle is suddenly accelerated based on at least one or more items of information of the engine RPM of the vehicle, the speed, the depressed state of the accelerator pedal, and the depressed state of the brake pedal detected by the sensor unit, and compensate braking force of the brake by generating hydraulic pressure through the hydraulic pressure compensation unit when the vehicle is suddenly accelerated.

2. The control system of claim 1, wherein the sensor unit includes at least one or more of:
an engine RPM detector configured to detect the engine RPM;
a speed detector that is a wheel speed sensor mounted on wheels of the vehicle and configured to detect the speed of the wheels;
an accelerator pedal-depressed state detector configured to detect the depressed state of the accelerator pedal;
a brake pedal-depressed state detector configured to detect the depressed state of the brake pedal; and
a vacuum pressure detector configured to detect vacuum pressure of the booster.

3. The control system of claim 1, wherein the controller includes:
a sudden acceleration state determiner configured to determine whether the vehicle is suddenly accelerated based on at least one or more items of information of the engine RPM of the vehicle, the speed, the depressed state of the accelerator pedal, and the depressed state of the brake pedal detected by the sensor unit; and
a hydraulic pressure compensation signal generator configured to generate a hydraulic pressure compensation signal to cause the hydraulic pressure compensation unit to compensate hydraulic pressure based on at least one or more items of information of the detected vacuum pressure of the booster, the depressed state of the brake pedal, and a deceleration state of the vehicle when the vehicle is suddenly accelerated.

4. The control system of claim 3, wherein the sudden acceleration state determiner is configured to start to determine whether the vehicle is suddenly accelerated when the current detected engine RPM of the vehicle is greater than predetermined engine RPM without the accelerator pedal depressed.

5. The control system of claim 3, wherein the sudden acceleration state determiner is configured to determine that the vehicle is suddenly accelerated when the accelerator pedal is disengaged, the current detected engine RPM of the vehicle is greater than predetermined engine RPM, the speed of the vehicle is a predetermined speed or greater, and the vehicle is not decelerated with the brake pedal depressed.

6. The control system of claim 3, wherein when the detected vacuum pressure of the booster is less than predetermined vacuum pressure, the hydraulic pressure compensation signal generator is configured to determine a hydraulic pressure compensation amount based on the detected vacuum pressure of the booster and generate a hydraulic pressure compensation signal to cause the hydraulic pressure compensation unit to compensate hydraulic pressure.

7. The control system of claim 3, wherein when the vehicle is not decelerated with the brake pedal depressed, the hydraulic pressure compensation signal generator is configured to generate a hydraulic pressure compensation signal to cause the hydraulic pressure compensation unit to compensate hydraulic pressure.

8. The control system of claim 3, wherein the hydraulic pressure compensation unit is configured to compensate hydraulic pressure of the brake by generating hydraulic pressure by operating a motor and a valve of an electric stability control (ESC) in response to a hydraulic compensation signal generated by the hydraulic pressure compensation signal generator.

9. The control system of claim 1, further comprising:
a parking brake operation unit operated by the controller to automatically operate a parking brake of the vehicle.

10. The control system of claim 9, wherein the controller is configured to operate the parking brake operation unit to stop a vehicle, when the speed of the vehicle becomes a predetermined speed or less by compensating the braking force of the brake by generating hydraulic pressure through the hydraulic pressure compensation unit in response to determining that the vehicle is suddenly accelerated.

11. A control method for preventing sudden acceleration of a vehicle, comprising:
determining, by a controller, whether a vehicle is suddenly accelerated based on at least one or more items of information of engine revolutions per minute (RPM) of a vehicle, speed, a depressed state of an accelerator pedal, and a depressed state of a brake pedal detected by a sensor unit; and
compensating, by the controller, braking force of a brake by generating hydraulic pressure through a hydraulic pressure compensation unit in response to determining that the vehicle is suddenly accelerated.

12. The control method of claim 11, wherein the determining of whether the vehicle is suddenly accelerated includes:
determining, by the controller, whether the current engine RPM of the vehicle is greater than predetermined reference engine RPM, and a depressed state of the accelerator pedal;
comparing, by the controller, the current speed of the vehicle with a predetermined reference speed in response to determining that the current engine RPM of the vehicle is greater than the predetermined reference engine RPM without the accelerator pedal depressed; and
determining, by the controller, whether the vehicle is decelerated, and the depressed state of the brake pedal in response to determining that the current speed of the vehicle is greater than the predetermined reference speed, and determining that the vehicle is suddenly accelerated in response to determining that the vehicle is not decelerated with the brake pedal depressed.

13. The control method of claim 11, wherein the compensating of braking force of a brake includes:
receiving, by the controller, a hydraulic pressure compensation signal to compensate hydraulic pressure by determining a hydraulic pressure compensation amount based on the detected vacuum pressure of a booster when the detected vacuum pressure of the booster is less than predetermined vacuum pressure; and
primarily compensating, by the controller, hydraulic pressure of a brake by generating hydraulic pressure by operating a motor and a valve of an electric stability control (ESC) in response to the hydraulic pressure compensation signal received by a hydraulic pressure compensation unit.

14. The control method of claim 12, further comprising:
after the primarily compensating of hydraulic pressure of a brake, determining, by the controller, a depressed state of the brake pedal and whether the vehicle is decelerated when the brake pedal is depressed; and
secondarily compensating, by the controller, the hydraulic pressure of the brake by generating hydraulic pressure by operating a motor and a valve of an electric stability control (ESC) when the vehicle is not decelerated.

15. The control method of claim 14, further comprising:
after the secondarily compensating of hydraulic pressure, stopping, by the controller, the vehicle by operating a parking brake operation unit when the speed of the vehicle becomes a predetermined speed or less.
